(19) United States
(12) Patent Application Publication
(10) Pub. No.: US 2020/0378018 A1
(43) Pub. Date: Dec. 3, 2020

(54) CARBON DOTS-BASED PHOTOCATALYTIC ELECTRODE FOR SIMULTANEOUS ORGANIC MATTER DEGRADATION AND HEAVY METAL REDUCTION AND USE THEREOF

(71) Applicant: CHINESE RESEARCH ACADEMY OF ENVIRONMENTAL SCIENCES, Beijing (CN)

(72) Inventors: Xiaosong HE, Beijing (CN); Mingxia ZHENG, Beijing (CN); Jun CUI, Beijing (CN); Beidou XI, Beijing (CN); Xuemei FU, Beijing (CN); Hongyu DING, Beijing (CN); Yuanyuan SUN, Beijing (CN)

(21) Appl. No.: 16/926,398

(22) Filed: Jul. 10, 2020

(30) Foreign Application Priority Data
Apr. 16, 2020 (CN) 202010298863.7
Apr. 27, 2020 (CN) 202010344416.0

(51) Int. Cl. C25B 11/12; C02F 1/467; C02F 1/461

(52) U.S. Cl. CPC C25B 11/12; C02F 1/4678; C02F 2101/30; C02F 2001/46133; C02F 1/46109

(57) ABSTRACT

The present invention discloses a carbon dots-based photocatalytic electrode for simultaneous organic matter degradation and heavy metal reduction and preparation method and use thereof, which belong to the field of multifunctional environmental materials and water treatment. With respect to the insufficient ability of simultaneous organic matter degradation and heavy metal reduction of existing photocatalytic electrodes, the present application provides a photocatalytic electrode with a Z-type heterojunction structure constructed by using carbon dots (CDs) as an electronic assistant. The directional transfer ability of photo-generated electrons is improved, while the recombination efficiency of photo-generated electrons and holes is reduced. The performance of a photocatalytic electrode in simultaneous organic matter degradation and heavy metal reduction is thereby improved. The invention provides a scientific basis and technical support for developing highly-efficient photocatalytic electrode materials and ensuring water quality safety.

### TECHNICAL FIELD

The invention belongs to the technical field of sewage treatment, and relates to a multifunctional environmental material and its use in water treatment. Particularly, the invention refers to a carbon dots-based photocatalytic electrode for organic matter degradation and simultaneous heavy metal reduction and preparation method and use thereof.

### BACKGROUND

Organic matter and heavy metals coexist in industrial wastewater, domestic sewage, agricultural sewage, etc., affecting public health and the quality of the water environment without an effective treatment. The concentrations of organic matter and heavy metals in water environment are strictly controlled in each country. Simultaneous organic matter degradation and heavy metal removal become one of the important and difficult issues in water treatment owing to the characteristics of organic matter (complex structure, high stability, poor biodegradability) and heavy metal (high solubility and high toxicity). Therefore, it is a challenge to develop water treatment technologies and materials. Therefore, it is of great importance to develop a technology for simultaneous organic matter degradation and heavy metal removal and preparation of corresponding environmental materials for water quality security and improvement of water environment.

Photocatalytic technology can be used to convert solar energy into electrical energy by catalytic materials and can be used for simultaneous organic matter degradation and heavy metal removal. Therefore, it is considered to be an environmental-friendly water treatment technology. When a photocatalytic material is in contact with a solution containing organic matter and heavy metals, the electrons inside the material will undergo energy level transitions under the excitation of light, from the valence band/highest occupied molecular orbital to the conduction band/lowest unoccupied molecular orbital, respectively, resulting in photo-generated electrons and holes. Both photo-generated electrons and holes are capable of reacting with medium to produce highly active intermediates to oxidize organic matter. Meanwhile, photo-generated electrons can reduce heavy metal ions. In order to increase the contact area between the catalyst and pollutants and improve the photocatalytic efficiency, the catalyst mainly exists in powder form (CN201711002731.X; CN201610534511.0 and CN201610512021.0). However, the powdery catalyst is difficult to recover and thus cause secondary pollution. Therefore, electrodes are prepared from powdery catalysts to avoid the problem of difficult recovery. However, catalytic electrodes have a much smaller specific surface area than powdery catalysts, resulting in reducing catalytic efficiency (Applied Catalysis B: Environmental, 2015, 164, 217-224; Chemical Engineering Journal, 2018, 344, 332-341). Meanwhile, the powdery catalysts do not tightly bind to the substrate, and tend to detach, resulting in secondary pollution. Therefore, development of efficient and stable catalytic electrodes is demanding and promising.

According to the energy band structure of electrode components, catalytic electrodes are generally divided into type I, type II, direct Z-type and indirect Z-type heterojunction structures. As well known, compared with the type I and type II heterojunction structures, the Z-type heterojunction structure has stronger electron transfer ability and less recombination of photo-generated electrons and holes due to its special structure, showing good potential for simultaneous organic matter degradation and heavy metal removal. However, the indirect Z-type heterojunctions mostly use metal atoms (Ag, Au, Bi, etc.) as an electronic medium (CN201310612197.X). In addition, some metal oxides and metal sulfides may also be used as an electronic medium. Carbon dots (CDs) are widely used to enhance the light absorption performance of photocatalytic materials (CN201710903335.8) due to their good light absorption performance. In addition, CDs also have a strong electron transfer capability and potential to act as an electron transmission medium. However, because of their water solubility and small size, CDs are extremely unstable. The water solubility of CDs, resulting in low catalytic efficiency (Carbon, 2014, 68, 718-724). This is one of the limiting factors for the construction of a carbon dots-based photocatalytic electrode with a Z-type heterojunction structure. Accordingly, in the present invention, CDs are used as an electronic assistant to achieve efficient simultaneous organic matter degradation and heavy metal removal by improving the binding ability of CDs to semiconductor I and semiconductor II. The invention thus provides theoretical teachings for preparation of a Z-type heterojunction photocatalytic electrode.

### SUMMARY

With respect to the insufficient ability of simultaneous organic matter degradation and heavy metal reduction of existing photocatalytic electrodes, the present application provides a Z-type heterojunction photocatalytic electrode constructed by using carbon dots as an electron transport layer (i.e., electronic assistant). The migration ability of photo-generated electrons is directionally improved, while the recombination efficiency of photo-generated electrons and holes is reduced. The performance of simultaneous organic matter degradation and heavy metal reduction is thereby improved.

For achieving the above purpose, in an aspect, the present invention provides a method for preparing a CDs-based photocatalytic electrode for simultaneous organic matter degradation and heavy metal reduction, comprising:

forming a CDs electron transport layer on a semiconductor I;

forming a semiconductor II on the CDs electron transport layer.

In some embodiments, the step of forming a CDs electron transport layer on the semiconductor I comprises:

immersing the semiconductor I in a mixed solution comprising 10 vol. %-30 vol. % (e.g., 15 vol %, 20 vol % or 25 vol %) mercaptopropionic acid (MPA) and 1-10 g/L (e.g., 2 g/L, 5 g/L or 8 g/L) CDs (preferably, the immersion time is 24-48 h), and then taking it out to obtain the semiconductor I-CDs electrode.

In some embodiments, the semiconductor I is a TiO₂ nanotube or a Fe₂O₃ nanotube.

In some embodiments, the TiO₂ nanotube is a TiO₂ nanotube prepared by anodization, and the Fe₂O₃ nanotube is a Fe₂O₃ nanotube prepared by anodization.

In some embodiments, the semiconductor II is an organic semiconductor or an inorganic semiconductor, wherein the organic semiconductor is polyaniline, reduced graphene oxide, carbon nitride, etc.; and the inorganic semiconductor is WO₃, MoS₂, etc.

It is understood by those skilled in the art that the carbon dots conventionally prepared in the prior art can be used to achieve the purpose of the present invention. In some embodiments, the method of preparing CDs comprises: dissolving glucose in concentrated H₂SO₄, heating at 180-220° C. (e.g., 190° C., 200° C. or 210° C.) for 3-5 h (e.g., 3.5 h, 4 h or 4.5 h), cooling to room temperature, adjusting the pH of the mixed solution to 6.9-7.1, extracting the supernatant after centrifugation by a solid phase extraction column, purging the extract with nitrogen and freeze-drying it (for example, freeze-drying time is 24-48 h) to obtain solid particles of carbon dots.

For example, in some embodiments, CDs were prepared by the following steps: 1-5 g glucose was dissolved in 150-200 mL 98 wt % concentrated H₂SO₄. After introduced into a reactor with an inner tank of polytetrafluoroethylene, the mixed solution of glucose and H₂SO₄ was heated at 180-220° C. for 3-5 h and then naturally cooled to room temperature. Next, the pH of the mixed solution was adjusted to 6.9-7.1 with Na₂CO₃. The mixed solution was then centrifuged for 10-20 min (e.g., 15 min) at 10000-15000 r/min (e.g., 12000 r/min) and the resultant supernatant was extracted with a solid phase extraction column (Oasis HLB, 3 cc/60 mg, Waters). The extraction step comprises four steps: an activation step, an enrichment step, a separation step and an elution step. Specifically, in the activation step, the solid phase extraction column was rinsed with 20 mL methanol, and the residual methanol in the solid phase extraction column was then washed away with 40 mL ultrapure water. In the enrichment step, 20 mL CDs solution was extracted with a solid phase extraction column. In the separation step, the solid phase extraction column was rinsed with 40 mL ultrapure water to dissolve impurities such as inorganic salts. In the elution step, the solid phase extraction column was rinsed with 20 mL methanol to desorb the CDs to obtain high-purity methanol solution of CDs as the extract. Finally, the extract was purged with nitrogen and freeze-dried for 24-48 h to obtain CDs solid particles.

In some embodiments, the semiconductor II may be polyaniline, and polyaniline may be formed on the CDs electron transport layer by in-situ electropolymerization.

For example, in some embodiments, a TiO₂ nanotube-CDs-PANI photocatalytic electrode was prepared by in-situ electropolymerization. The TiO₂ nanotube-CDs electrode, a platinum sheet and Ag/AgCl were used as a working electrode, a counter electrode and a reference electrode, respectively. The electrolyte was an acetone solution comprising 0.1-0.5 M (for example 0.2 M) aniline and 0.01-0.1M (for example 0.05 M) citric acid. The electrolyte was deoxygenated with nitrogen for 30 minutes before in-situ electropolymerization. In-situ electropolymerization of aniline was carried out using cyclic voltammetry (potential: 0-0.8 V; number of polymerization cycles: 10-30 cycles). After polymerization, The working electrode was dried at 40-80° C. for 24-48 h to obtain a TiO₂ nanotube-CDs-PANI photocatalytic electrode.

In some embodiments, the semiconductor II may be WO₃, and WO₃ may be formed on the carbon dots electron transport layer by electrodeposition.

For example, in some embodiments, the TiO₂ nanotube-CDs-WO₃ photocatalytic electrode was prepared by electrodeposition. The TiO₂ nanotube-CDs electrode, a platinum sheet and Ag/AgCl were used as a working electrode, a counter electrode and a reference electrode, respectively. The electrolyte was an aqueous solution comprising 20-30 mM (e.g., 25 mM) Na₂WO₄ and 20-40 mM (e.g., 30 mM) H₂O₂, and the pH of the solution was adjusted to 1.4±0.1 with 0.01 M HNO₃. The deposition voltage was −0.437 V_{Ag/AgCl}, and the deposition time was 100-200 s (for example, 150 s). The resulting electrode was cured at 40-80° C. for 12-24 h to obtain the TiO₂ nanotube-CDs-WO₃ photocatalytic electrode.

In some embodiments, the semiconductor II may be carbon nitride, and carbon nitride may be formed on the CDs electron transport layer by a hydrothermal method.

For example, in some embodiments, the Fe₂O₃ nanotube-CDs-carbon nitride photocatalytic electrode was prepared by a hydrothermal method. The prepared Fe₂O₃ nanotube-CDs electrode was immersed in an aqueous solution containing melamine (10%-30 wt %) and then incubated at 80° C. for 24-72 h to obtain the Fe₂O₃ nanotube-CDs-carbon nitride photocatalytic electrode.

In another aspect, the present invention provides a photocatalytic electrode prepared by said method.

In a further aspect, the present invention also provides a method for simultaneously degrading organic matter and reducing heavy metals using the photocatalytic electrode, comprising:

immersing the photocatalytic electrode in a solution containing organic pollutants and heavy metals, and performing the degradation of organic pollutants and reduction of heavy metals under light exposure.

In some embodiments, the reaction conditions are as follows: light intensity: more than 50 mW·cm⁻²; wavelength: more than 200 nm; the ratio of electrode working area to solution volume: 1-10 cm²·L⁻¹; organic pollutant concentration: less than 1 M; heavy metal concentration: less than 10 M; and reaction time: 30-120 min (such as 60 min or 90 min).

The advantages of the present invention over existing photocatalytic electrodes are:

(1) In contrast to the existing photocatalytic electrodes, CDs are not only used as a light absorbing material, but also are used as an electron assistant. The directional migration ability of photo-generated electrons is improved, and the problem of reduced efficiency of simultaneous organic matter degradation and heavy metal reduction caused by electron-hole pair recombination is avoided.

(2) High water solubility of CDs leads to insufficient ability of simultaneous organic metal degradation and heavy metal reduction. The introduction of mercaptopropionic acid (MPA) improves the binding energy of carbon dots with semiconductor I and semiconductor II. As a result, the long-term efficient and stable ability of the photocatalytic electrode in simultaneous organic matter degradation and heavy metal reduction may be ensured.

### BRIEF DESCRIPTION OF DRAWINGS

The following drawings are only intended to schematically illustrate and explain the present invention, and are not intended to limit the scope of the present invention.

FIG. 1 is an XPS diagram of CDs obtained in an example of the present invention.

FIG. 2 is a transmission electron microscope diagram of CDs obtained in an example of the present invention.

FIG. 3 is a scanning electron microscope image obtained in an example of the present invention, (a) TiO₂ nanotubes, (b) TiO₂ nanotubes-CDs, (c) TiO₂ nanotubes-CDs-WO₃, (d) TiO₂ nanotubes-CDs-PANI.

FIG. 4 is a structural diagram of a TiO₂ nanotube-CDs-PANI electrode obtained in an example of the present invention.

FIG. 5 is a graph showing the light absorption properties of (a) TiO₂ nanotube-CDs-WO₃ and (b) TiO₂ nanotube-CDs-PANI obtained in the examples of the present invention.

FIG. 6 is a graph showing the photoelectric conversion performance of (a) TiO₂ nanotube-CDs-WO3 and (b) TiO₂ nanotube-CDs-PANI obtained in an example of the present invention.

FIG. 7 is a scanning electron microscope image of Fe₂O₃ nanotube-CDs-carbon nitride obtained in an example of the present invention.

FIG. 8 is a graph showing the photoelectric conversion performance of Fe₂O₃ nanotube-CDs-carbon nitride photocatalytic electrode obtained in an example of the present invention.

FIG. 9 is a graph showing the organic matter degradation efficiency of an example of the present invention.

FIG. 10 is a graph showing the heavy metal reduction efficiency of an example of the present invention.

FIG. 11 is a graph showing the organic matter degradation efficiency in Comparative Example 1 of the present invention.

FIG. 12 is a graph showing the heavy metal reduction efficiency in Comparative Example 1 of the present invention.

FIG. 13 is a graph showing the organic matter degradation efficiency in Comparative Example 2 of the present invention.

FIG. 14 is a graph showing the heavy metal reduction efficiency in Comparative Example 2 of the present invention.

### DETAILED DESCRIPTION

In order to facilitate understanding of the above features and advantages of the present invention, the present invention is illustrated in detail by the embodiments in combination with the accompanying drawings, but the present invention is not limited thereto.

In some embodiments of the present invention, a TiO₂ nanotube-CDs-PANI photocatalytic electrode is prepared using TiO₂ nanotubes as semiconductor I and polyaniline (PANI) as organic semiconductor II, and a TiO₂ nanotube-CDs-WO₃ photocatalytic electrode is prepared using TiO₂ nanotubes as semiconductor I and WO₃ as inorganic semiconductor II.

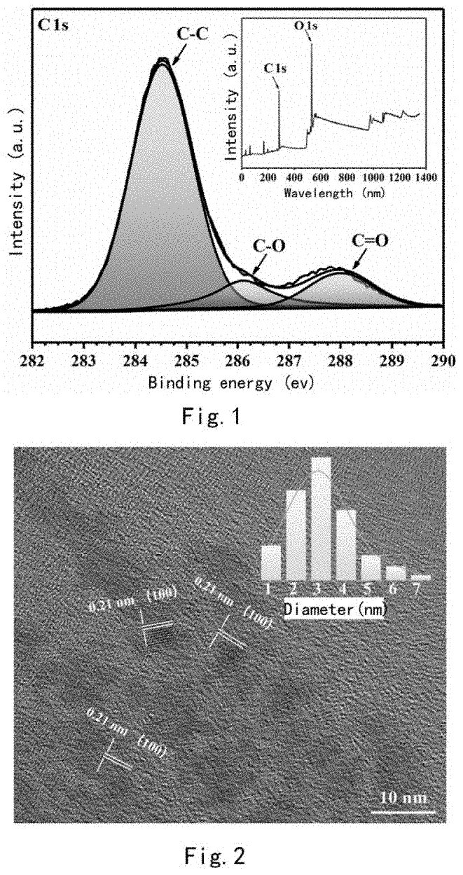

As shown in FIG. 1, there are three distinct characteristic peaks in the C 1 s high-resolution spectrum of CDs, which are located at 284.5 eV, 286.2 eV and 288.1 eV, respectively. It is indicated that there are C—C (C═C), C—O and C═O on the surface of CDs, consistent with the characteristics of CDs.

As shown in FIG. 2, the diameter of CDs is mainly distributed in the range of 2-4 nm. According to the lattice fringes, the spacing between the crystal planes is 0.21 nm, indicating that the exposed surface of CDs is the (100) crystal plane. The successful synthesis of CDs is proven by FIG. 1 in combination with FIG. 2.

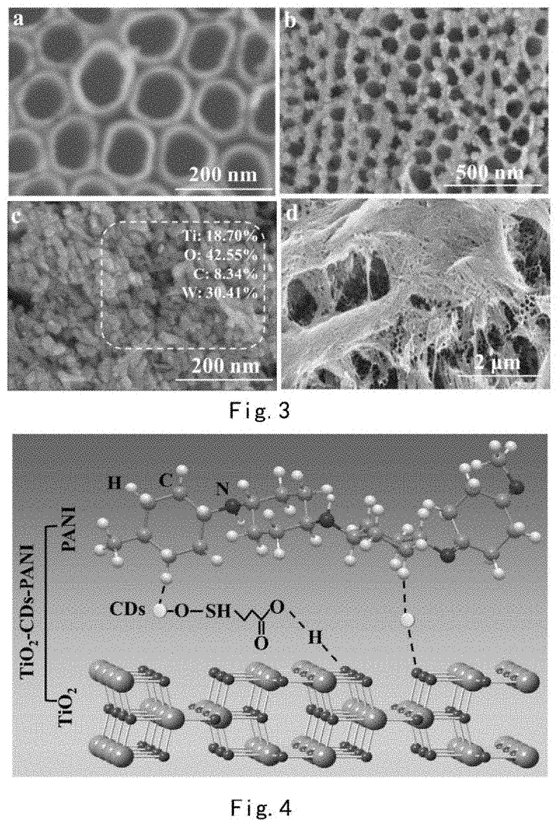

As shown in FIG. 3, an obvious TiO₂ nanotube array structure can be observed from FIG. 3a, wherein the outer diameter of the TiO₂ nanotube is about 90 nm, and the inner diameter is about 80 nm. From FIG. 3b, it can be observed that large amounts of aggregated CDs are adsorbed on the surface of the nanotube tube. It can be observed from FIG. 3c that a large amount of WO₃ nanoparticles are successfully loaded on the surface of the TiO₂ nanotube-CDs electrode. From FIG. 3d, it can be observed that a large number of PANI nanowires are successfully loaded on the surface of the TiO₂ nanotube-CDs electrode.

As shown in FIG. 4, mercaptopropionic acid (MPA) has both —COOH and —SH functional groups, respectively connected to TiO₂ nanotubes and CDs, to ensure the stability of TiO₂ nanotube-CDs photocatalytic electrode. CDs and PANI are connected in the forms of PANI-H...O-CQDs...O—TiO₂, PANI-N...O-CQDs, PANI-N...H bond...O-CQDs, PANI-H...O-CQDs and the like to ensure the stability of TiO₂ nanotube-CDs-PANI.

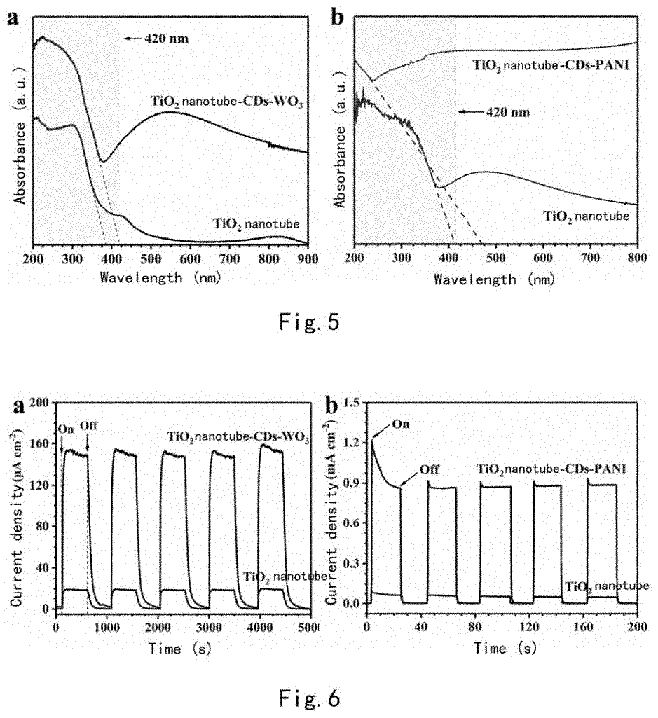

As shown in FIG. 5, in contrast to TiO₂ nanotubes, the band gap width of TiO₂ nanotube-CDs-PANI and TiO₂ nanotube-CDs-WO₃ photocatalytic electrodes is significantly reduced, while the light absorption capacity in the range of 200-800 nm is significant enhanced, especially the absorption of visible and near-infrared light with a wavelength greater than 420 nm. Therefore, the photocatalytic electrodes show good potential photocatalytic performance.

As shown in FIG. 6, in contrast to TiO₂ nanotubes, the photoelectric conversion performance of TiO₂ nanotubes-CDs-PANI and TiO₂ nanotubes-CDs-WO₃ photocatalytic electrodes is significantly improved by 8.1 times and 18.8 times, respectively. Therefore, the photocatalytic electrodes show good potential photocatalytic performance.

In other embodiments of the present invention, Fe₂O₃ nanotube-CDs-carbon nitride photocatalytic electrode is prepared by using Fe₂O₃ nanotubes as semiconductor I and carbon nitride as semiconductor II.

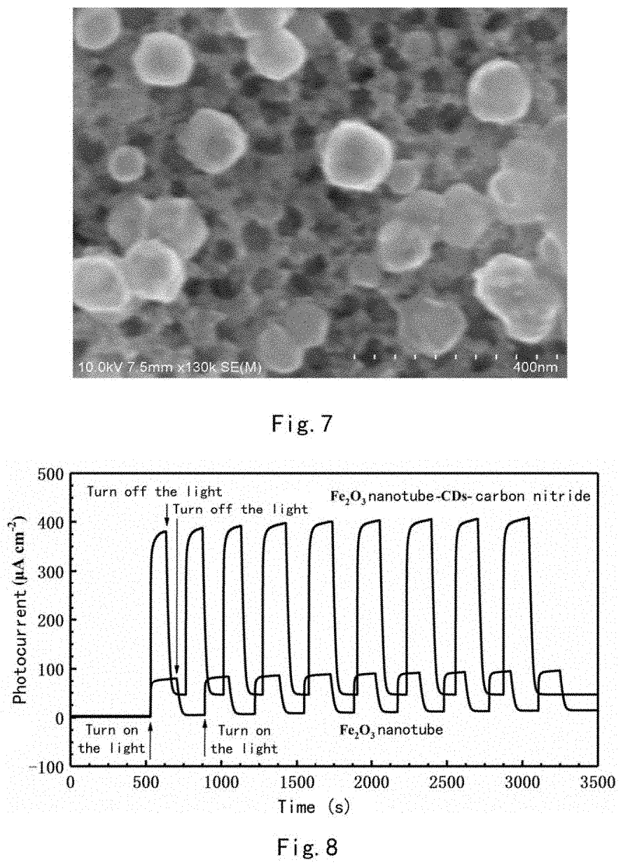

From FIG. 7, the obvious Fe₂O₃ nanotube-CDs-carbon nitride structure can be observed, wherein the outer diameter of the Fe₂O₃ nanotube is about 80 nm, and the inner diameter is about 70 nm. It can be observed that large amounts of aggregated CDs are adsorbed on the surface of the nanotubes. In addition, carbon nitride nanoparticles with a diameter of about 100 nm can also be observed. It is noted that due to the magnetic properties of Fe₂O₃, astigmatism is inevitable when observed through scanning electron microscopy.

As shown in FIG. 8, in contrast to Fe₂O₃ nanotubes, the photoelectric conversion performance of Fe₂O₃ nanotubes-CDs-carbon nitride photocatalytic electrode is significantly improved by 4.1 times. Therefore, the photocatalytic electrode shows good potential photocatalytic performance.

It should be understood that the semiconductor I and the semiconductor II in the present invention are not limited to the semiconductor materials in the Examples.

### EXAMPLE 1

CDs were prepared by the following steps. 2.5 g glucose was dissolved in 150 mL 98 wt % concentrated H₂SO₄. After introduced into a reactor with an inner tank of polytetrafluoroethylene, the mixed solution of glucose and H₂SO₄ was heated at 180° C. for 3 h and then naturally cooled to room temperature. Next, the pH of the mixed solution was adjusted to 7 with Na₂CO₃. The mixed solution was centrifuged for 15 min at 12000 r/min and the resultant supernatant was extracted with a solid phase extraction column (Oasis HLB, 3 cc/60 mg, Waters). The extraction step comprises four steps: an activation step, an enrichment step, a separation step and an elution step. Specifically, in the activation step, the solid phase extraction column was rinsed with 20 mL methanol, and the residual methanol in the solid phase extraction column was then washed away with 40 mL ultrapure water. In the enrichment step, 20 mL CDs solution was extracted with a solid phase extraction column. In the separation step, the solid phase extraction column was rinsed with 40 mL ultrapure water to dissolve impurities such as inorganic salts. In the elution step, the solid phase extraction column was rinsed with 20 mL methanol to desorb the CDs to obtain high-purity methanol solution of CDs as the extract. Finally, the extract was purged with nitrogen and freeze-dried for 48 h to obtain CDs solid particles.

TiO₂ nanotubes were prepared by anodization. The TiO₂ nanotubes were immersed in a mixed solution of 10% by volume mercaptopropionic acid (MPA) and 7 g/L CDs, and were taken out after immersion for 24 h to obtain TiO₂ nanotube-CDs electrode.

The TiO₂ nanotube-CDs-PANI photocatalytic electrode was prepared by in-situ electropolymerization. The TiO₂ nanotube-CDs electrode, a platinum sheet and Ag/AgCl were used as a working electrode, a counter electrode and a reference electrode, respectively. The electrolyte was an acetone solution comprising 0.2 M aniline and 0.05 M citric acid. The electrolyte was deoxygenated with nitrogen for 30 minutes before in-situ electropolymerization. In-situ electropolymerization of aniline was carried out using cyclic voltammetry (potential: 0-0.8 V; number of polymerization cycles: 10 cycles). The working electrode after polymerization was dried at 40° C. for 48 h to obtain a TiO₂ nanotube-CDs-PANI photocatalytic electrode.

TiO₂ nanotube-CDs-WO₃ photocatalytic electrode was prepared by electrodeposition method. The TiO₂ nanotube-CDs electrode, a platinum sheet and Ag/AgCl were used as a working electrode, a counter electrode and a reference electrode, respectively. The electrolyte was 25 mM Na₂WO₄ and 30 mM H₂O₂ in water, and the pH of the solution was adjusted to 1.4±0.1 with 0.01 M HNO₃. The deposition voltage was −0.437 V_{Ag/AgCl}, and the deposition time was 150 s. The resulting electrode was cured at 60° C. for 24 h to obtain the TiO₂ nanotube-CDs-WO₃ photocatalytic electrode.

An experiment of simultaneous organic matter degradation and heavy metal reduction was performed using the prepared photocatalytic electrode. In particular, the photocatalytic electrode was immersed in a solution containing a certain concentration of organic pollutants and heavy metals, and then the working surface of the photocatalytic electrode was exposed to simulated sunlight for organic pollutant degradation and heavy metal reduction. The specific conditions were as follows: light intensity: 100 mW·cm⁻², wavelength: more than 420 nm; the ratio of electrode working area to solution volume: 7.5 cm²·L⁻¹; organic pollutant (carbamazepine) concentration: 1 μM; heavy metal (hexavalent chromium) concentration: 0.68 mM; reaction time: 60 min; no requirement of adjusting the pH value of the reaction system; and no requirement of aerating the reaction system.

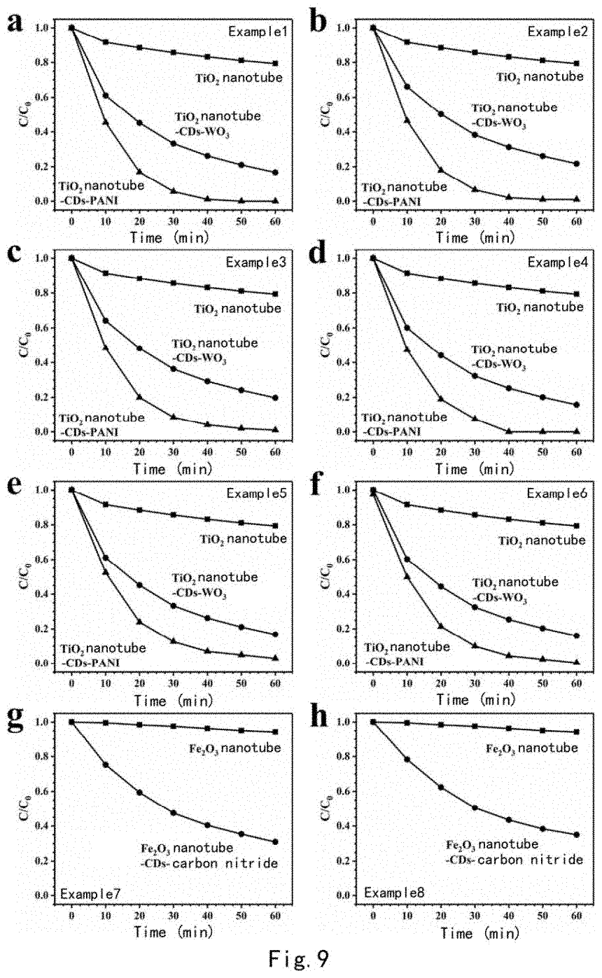

As shown in FIG. 9, after loading of CDs and PANI, or CDs and WO₃, the degradation efficiency of the photocatalytic electrode on organic matter was increased from 21% (TiO₂ nanotubes) to 100% (TiO₂ nanotubes-CDs-PANI) and 84% (TiO₂ nanotubes-CDs-WO₃), showing an excellent degradation efficiency of organic matter.

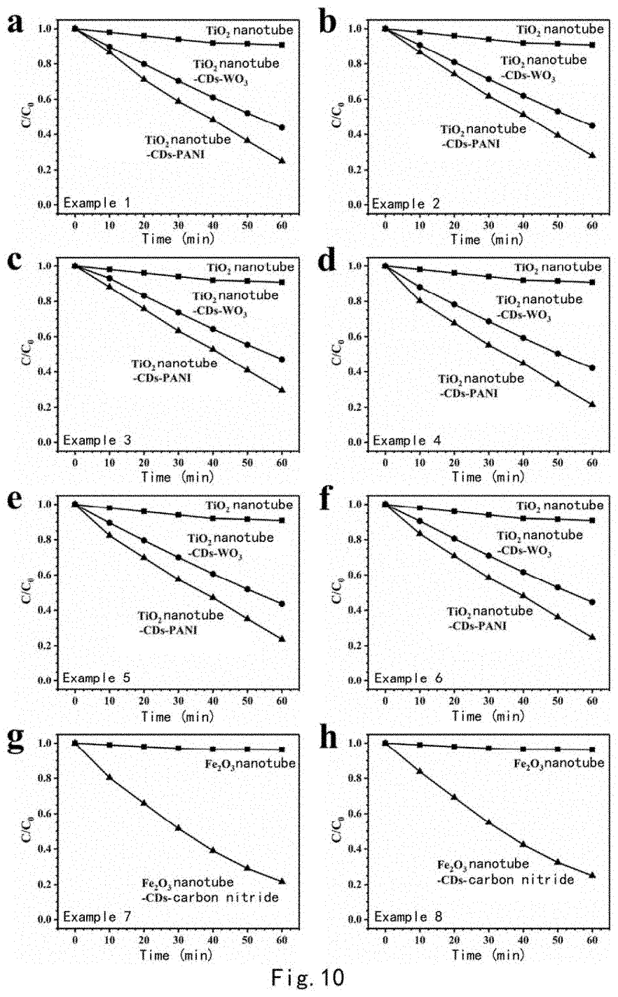

As shown in FIG. 10, after loading of CDs and PANI, or CDs and WO₃, the reduction efficiency of the photocatalytic electrode on heavy metals was increased from 10% (TiO₂ nanotubes) to 76% (TiO₂ nanotubes-CDs-PANI) and 57% (TiO₂ Nanotube-CDs-WO₃), showing an excellent reduction efficiency of heavy metal.

### EXAMPLE 2

CDs were prepared by the following steps. 1 g glucose was dissolved in 200 mL 98 wt % concentrated H₂SO₄. After introduced into a reactor with an inner tank of polytetrafluoroethylene, the mixed solution of glucose and H₂SO₄ was heated at 200° C. for 5 h and then naturally cooled to room temperature. Next, the pH of the mixed solution was adjusted to 7 with Na₂CO₃. The mixed solution was centrifuged for 15 min at 12000 r/min and the resultant supernatant was extracted with a solid phase extraction column (Oasis HLB, 3 cc/60 mg, Waters). The extraction step comprises four steps: an activation step, an enrichment step, a separation step and an elution step. Specifically, in the activation step, the solid phase extraction column was rinsed with 20 mL methanol, and the residual methanol in the solid phase extraction column was then washed away with 40 mL ultrapure water. In the enrichment step, 20 mL CDs solution was extracted with a solid phase extraction column. In the separation step, the solid phase extraction column was rinsed with 40 mL ultrapure water to dissolve impurities such as inorganic salts. In the elution step, the solid phase extraction column was rinsed with 20 mL methanol to desorb the CDs to obtain high-purity methanol solution of CDs as the extract. Finally, the extract was purged with nitrogen and freeze-dried for 48 h to obtain CDs solid particles.

TiO₂ nanotubes were prepared by anodization. The TiO₂ nanotubes were immersed in a mixed solution of 30% by volume mercaptopropionic acid (MPA) and 10 g/L CDs, and were taken out after immersion for 48 h to obtain TiO₂ nanotube-CDs electrode.

The TiO₂ nanotube-CDs-PANI photocatalytic electrode was prepared by in-situ electropolymerization. The TiO₂ nanotube-CDs electrode, a platinum sheet and Ag/AgCl were used as a working electrode, a counter electrode and a reference electrode, respectively. The electrolyte was an acetone solution comprising 0.2 M aniline and 0.05 M citric acid. The electrolyte was deoxygenated with nitrogen for 30 minutes before in-situ electropolymerization. In-situ electropolymerization of aniline was carried out using cyclic voltammetry (potential: 0-0.8 V; number of polymerization cycles: 20 cycles). The working electrode after polymerization was dried at 60° C. for 36 h to obtain a TiO₂ nanotube-CDs-PANI photocatalytic electrode.

TiO₂ nanotube-CDs-WO₃ photocatalytic electrode was prepared by electrodeposition method. The TiO₂ nanotube-CDs electrode, a platinum sheet and Ag/AgCl were used as a working electrode, a counter electrode and a reference electrode, respectively. The electrolyte was 25 mM Na₂WO₄ and 30 mM H₂O₂ in water, and the pH of the solution was adjusted to 1.4±0.1 with 0.01 M HNO₃. The deposition voltage was −0.437 V_{Ag/AgCl}, and the deposition time was 150 s. The resulting electrode was cured at 40° C. for 24 h to obtain the TiO₂ nanotube-CDs-WO₃ photocatalytic electrode.

An experiment of simultaneous organic matter degradation and heavy metal reduction was performed using the prepared photocatalytic electrode. The photocatalytic electrode was immersed in a solution containing a certain concentration of organic pollutants and heavy metals, and then the working surface of the photocatalytic electrode was exposed to simulated sunlight for organic pollutant degradation and heavy metal reduction. The specific conditions were as follows: light intensity: 100 mW·cm⁻², wavelength: more than 420 nm; the ratio of electrode working area to solution volume: 7.5 cm²·L⁻¹; organic pollutant (carbamazepine) concentration: 100 μM; heavy metal (hexavalent chromium) concentration: 68 mM; reaction time: 60 min; no requirement of adjusting the pH value of the reaction system; and no requirement of aerating the reaction system.

As shown in FIG. 9, after loading of CDs and PANI, or CDs and WO₃, the degradation efficiency of the photocatalytic electrode on organic matter was increased from 21% (TiO₂ nanotubes) to 100% (TiO₂ nanotubes-CDs-PANI) and 79% (TiO₂ nanotubes-CDs-WO₃), showing an excellent degradation effect of organic matter.

As shown in FIG. 10, after loading of CDs and PANI, or CDs and WO₃, the reduction efficiency of the photocatalytic electrode on heavy metals was increased from 10% (TiO₂ nanotubes) to 73% (TiO₂ nanotubes-CDs-PANI) and 56% (TiO₂ Nanotube-CDs-WO₃), showing an excellent reduction efficiency of heavy metal.

### EXAMPLE 3

CDs were prepared by the following steps. 5 g glucose was dissolved in 150 mL 98 wt % concentrated H₂SO₄. After introduced into a reactor with an inner tank of polytetrafluoroethylene, the mixed solution of glucose and H₂SO₄ was heated at 220° C. for 5 h and then naturally cooled to room temperature. Next, the pH of the mixed solution was adjusted to 7 with Na₂CO₃. The mixed solution was centrifuged for 15 min at 12000 r/min and the resultant supernatant was extracted with a solid phase extraction column (Oasis HLB, 3 cc/60 mg, Waters). The extraction step comprises four steps: an activation step, an enrichment step, a separation step and an elution step. Specifically, in the activation step, the solid phase extraction column was rinsed with 20 mL methanol, and the residual methanol in the solid phase extraction column was then washed away with 40 mL ultrapure water. In the enrichment step, 20 mL CDs solution was extracted with a solid phase extraction column. In the separation step, the solid phase extraction column was rinsed with 40 mL ultrapure water to dissolve impurities such as inorganic salts. In the elution step, the solid phase extraction column was rinsed with 20 mL methanol to desorb the CDs to obtain high-purity methanol solution of CDs as the extract. Finally, the extract was purged with nitrogen and freeze-dried for 48 h to obtain CDs solid particles.

TiO₂ nanotubes were prepared by anodization. The TiO₂ nanotubes were immersed in a mixed solution of 25% by volume mercaptopropionic acid (MPA) and 6 g/L CDs, and were taken out after immersion for 24 h to obtain TiO₂ nanotube-CDs electrode.

The TiO₂ nanotube-CDs-PANI photocatalytic electrode was prepared by in-situ electropolymerization. The TiO₂ nanotube-CDs electrode, a platinum sheet and Ag/AgCl were used as a working electrode, a counter electrode and a reference electrode, respectively. The electrolyte was an acetone solution comprising 0.2 M aniline and 0.05 M citric acid. The electrolyte was deoxygenated with nitrogen for 30 minutes before in-situ electropolymerization. In-situ electropolymerization of aniline was carried out using cyclic voltammetry (potential: 0-0.8 V; number of polymerization cycles: 30 cycles). The working electrode after polymerization was dried at 80° C. for 24 h to obtain a TiO₂ nanotube-CDs-PANI photocatalytic electrode.

TiO₂ nanotube-CDs-WO₃ photocatalytic electrode was prepared by electrodeposition method. The TiO₂ nanotube-CDs electrode, a platinum sheet and Ag/AgCl were used as a working electrode, a counter electrode and a reference electrode, respectively. The electrolyte was 25 mM Na₂WO₄ and 30 mM H₂O₂ in water, and the pH of the solution was adjusted to 1.4±0.1 with 0.01 M HNO₃. The deposition voltage was −0.437 V_{Ag/AgCl}, and the deposition time was 150 s. The resulting electrode was cured at 80° C. for 24 h to obtain the TiO₂ nanotube-CDs-WO₃ photocatalytic electrode.

An experiment of simultaneous organic matter degradation and heavy metal reduction was performed using the prepared photocatalytic electrode. The photocatalytic electrode was immersed in a solution containing a certain concentration of organic pollutants and heavy metals, and then the working surface of the photocatalytic electrode was exposed to simulated sunlight for organic pollutant degradation and heavy metal reduction. The specific conditions were as follows: light intensity: 100 mW·cm⁻², wavelength: more than 420 nm; the ratio of electrode working area to solution volume: 7.5 cm²·L⁻¹; organic pollutant (carbamazepine) concentration: 1M; heavy metal (hexavalent chromium) concentration: 0.68 M; reaction time: 60 min; no requirement of adjusting the pH value of the reaction system; and no requirement of aerating the reaction system.

As shown in FIG. 9, after loading of CDs and PANI, or CDs and WO₃, the degradation efficiency of the photocatalytic electrode on organic matter was increased from 21% (TiO₂ nanotubes) to 100% (TiO₂ nanotubes-CDs-PANI) and 81% (TiO₂ nanotubes-CDs-WO₃), showing an excellent degradation efficiency of organic matter.

As shown in FIG. 10, after loading of CDs and PANI, or CDs and WO₃, the reduction efficiency of the photocatalytic electrode on heavy metals was increased from 10% (TiO₂ nanotubes) to 71% (TiO₂ nanotubes-CDs-PANI) and 53% (TiO₂ nanotube-CDs-WO₃), showing an excellent reduction efficiency of heavy metal.

### EXAMPLE 4

CDs were prepared by the following steps. 3 g glucose was dissolved in 180 mL 98 wt % concentrated H₂SO₄. After introduced into a reactor with an inner tank of polytetrafluoroethylene, the mixed solution of glucose and H₂SO₄ was heated at 190° C. for 4 h and then naturally cooled to room temperature. Next, the pH of the mixed solution was adjusted to 7 with Na₂CO₃. The mixed solution was centrifuged for 15 min at 12000 r/min and the resultant supernatant was extracted with a solid phase extraction column (Oasis HLB, 3 cc/60 mg, Waters). The extraction step comprises four steps: an activation step, an enrichment step, a separation step and an elution step. Specifically, in the activation step, the solid phase extraction column was rinsed with 20 mL methanol, and the residual methanol in the solid phase extraction column was then washed away with 40 mL ultrapure water. In the enrichment step, 20 mL CDs solution was extracted with a solid phase extraction column. In the separation step, the solid phase extraction column was rinsed with 40 mL ultrapure water to dissolve impurities such as inorganic salts. In the elution step, the solid phase extraction column was rinsed with 20 mL methanol to desorb the CDs to obtain high-purity methanol solution of CDs as the extract. Finally, the extract was purged with nitrogen and freeze-dried for 48 h to obtain CDs solid particles.

TiO₂ nanotubes were prepared by anodization. The TiO₂ nanotubes were immersed in a mixed solution of 18% by volume mercaptopropionic acid (MPA) and 7 g/L CDs, and were taken out after immersion for 36 h to obtain TiO₂ nanotube-CDs electrode.

The TiO₂ nanotube-CDs-PANI photocatalytic electrode was prepared by in-situ electropolymerization. The TiO₂ nanotube-CDs electrode, a platinum sheet and Ag/AgCl were used as a working electrode, a counter electrode and a reference electrode, respectively. The electrolyte was an acetone solution comprising 0.2 M aniline and 0.05 M citric acid. The electrolyte was deoxygenated with nitrogen for 30 minutes before in-situ electropolymerization. In-situ electropolymerization of aniline was carried out using cyclic voltammetry (potential: 0-0.8 V; number of polymerization cycles: 15 cycles). The working electrode after polymerization was dried at 60° C. for 24 h to obtain a TiO₂ nanotube-CDs-PANI photocatalytic electrode.

TiO₂ nanotube-CDs-WO₃ photocatalytic electrode was prepared by electrodeposition method. The TiO₂ nanotube-CDs electrode, a platinum sheet and Ag/AgCl were used as a working electrode, a counter electrode and a reference electrode, respectively. The electrolyte was 25 mM Na₂WO₄ and 30 mM H₂O₂ in water, and the pH of the solution was adjusted to 1.4±0.1 with 0.01 M HNO₃. The deposition voltage was −0.437 V_{Ag/AgCl}, and the deposition time was 150 s. The resulting electrode was cured at 60° C. for 18 h to obtain the TiO₂ nanotube-CDs-WO₃ photocatalytic electrode.

An experiment of simultaneous organic matter degradation and heavy metal reduction was performed using the prepared photocatalytic electrode. The photocatalytic electrode was immersed in a solution containing a certain concentration of organic pollutants and heavy metals, and then the working surface of the photocatalytic electrode was exposed to simulated sunlight for organic pollutant degradation and heavy metal reduction. The specific conditions were as follows: light intensity: 100 mW·cm⁻², wavelength: more than 420 nm; the ratio of electrode working area to solution volume: 7.5 cm²·L⁻¹; organic pollutant (carbamazepine) concentration: 1M; heavy metal (hexavalent chromium) concentration: 6.8 M; reaction time: 60 min; no requirement of adjusting the pH value of the reaction system; and no requirement of aerating the reaction system.

As shown in FIG. 9, after loading of CDs and PANI, or CDs and WO₃, the degradation efficiency of the photocatalytic electrode on organic matter was increased from 21% (TiO₂ nanotubes) to 100% (TiO₂ nanotubes-CDs-PANI) and 85% (TiO₂ nanotubes-CDs-WO₃), showing an excellent degradation efficiency of organic matter.

As shown in FIG. 10, after loading of CDs and PANI, or CDs and WO₃, the reduction efficiency of the photocatalytic electrode on heavy metals was increased from 10% (TiO₂ nanotubes) to 79% (TiO₂ nanotubes-CDs-PANI) and 58% (TiO₂ nanotube-CDs-WO₃), showing an excellent reduction efficiency of heavy metal.

### EXAMPLE 5

CDs were prepared by the following steps. 2 g glucose was dissolved in 150 mL 98 wt % concentrated H₂SO₄. After introduced into a reactor with an inner tank of polytetrafluoroethylene, the mixed solution of glucose and H₂SO₄ was heated at 200° C. for 3 h and then naturally cooled to room temperature. Next, the pH of the mixed solution was adjusted to 7 with Na₂CO₃. The mixed solution was centrifuged for 15 min at 12000 r/min and the resultant supernatant was extracted with a solid phase extraction column (Oasis HLB, 3 cc/60 mg, Waters). The extraction step comprises four steps: an activation step, an enrichment step, a separation step and an elution step. Specifically, in the activation step, the solid phase extraction column was rinsed with 20 mL methanol, and the residual methanol in the solid phase extraction column was then washed away with 40 mL ultrapure water. In the enrichment step, 20 mL CDs solution was extracted with a solid phase extraction column. In the separation step, the solid phase extraction column was rinsed with 40 mL ultrapure water to dissolve impurities such as inorganic salts. In the elution step, the solid phase extraction column was rinsed with 20 mL methanol to desorb the CDs to obtain high-purity methanol solution of CDs as the extract. Finally, the extract was purged with nitrogen and freeze-dried for 48 h to obtain CDs solid particles.

TiO₂ nanotubes were prepared by anodization. The TiO₂ nanotubes were immersed in a mixed solution of 10% by volume mercaptopropionic acid (MPA) and 10 g/L CDs, and were taken out after immersion for 48 h to obtain TiO₂ nanotube-CDs electrode.

The TiO₂ nanotube-CDs-PANI photocatalytic electrode was prepared by in-situ electropolymerization. The TiO₂ nanotube-CDs electrode, a platinum sheet and Ag/AgCl were used as a working electrode, a counter electrode and a reference electrode, respectively. The electrolyte was an acetone solution comprising 0.2 M aniline and 0.05 M citric acid. The electrolyte was deoxygenated with nitrogen for 30 minutes before in-situ electropolymerization. In-situ electropolymerization of aniline was carried out using cyclic voltammetry (potential: 0-0.8 V; number of polymerization cycles: 10 cycles). The working electrode after polymerization was dried at 60° C. for 24 h to obtain a TiO₂ nanotube-CDs-PANI photocatalytic electrode.

TiO₂ nanotube-CDs-WO₃ photocatalytic electrode was prepared by electrodeposition method. The TiO₂ nanotube-CDs electrode, a platinum sheet and Ag/AgCl were used as a working electrode, a counter electrode and a reference electrode, respectively. The electrolyte was 25 mM Na₂WO₄ and 30 mM H₂O₂ in water, and the pH of the solution was adjusted to 1.4±0.1 with 0.01 M HNO₃. The deposition voltage was −0.437 V_{Ag/AgCl}, and the deposition time was 150 s. The resulting electrode was cured at 60° C. for 12 h to obtain the TiO₂ nanotube-CDs-WO₃ photocatalytic electrode.

An experiment of simultaneous organic matter degradation and heavy metal reduction was performed using the prepared photocatalytic electrode. The photocatalytic electrode was immersed in a solution containing a certain concentration of organic pollutants and heavy metals, and then the working surface of the photocatalytic electrode was exposed to simulated sunlight for organic pollutant degradation and heavy metal reduction. The specific conditions were as follows: light intensity: 100 mW·cm⁻², wavelength: more than 420 nm; the ratio of electrode working area to solution volume: 7.5 cm²·L⁻¹; organic pollutant (carbamazepine) concentration: 10 μM; heavy metal (hexavalent chromium) concentration: 0.68 mM; reaction time: 60 min; no requirement of adjusting the pH value of the reaction system; and no requirement of aerating the reaction system.

As shown in FIG. 9, after loading of CDs and PANI, or CDs and WO₃, the degradation efficiency of the photocatalytic electrode on organic matter was increased from 21% (TiO₂ nanotubes) to 100% (TiO₂ nanotubes-CDs-PANI) and 84% (TiO₂ nanotubes-CDs-WO₃), showing an excellent degradation efficiency of organic matter.

As shown in FIG. 10, after loading of CDs and PANI, or CDs and WO₃, the reduction efficiency of the photocatalytic electrode on heavy metals was increased from 10% (TiO₂ nanotubes) to 73% (TiO₂ nanotubes-CDs-PANI) and 57% (TiO₂ nanotube-CDs-WO₃), showing an excellent reduction efficiency of heavy metal.

### EXAMPLE 6

CDs were prepared by the following steps. 4 g glucose was dissolved in 180 mL 98 wt % concentrated H₂SO₄. After introduced into a reactor with an inner tank of polytetrafluoroethylene, the mixed solution of glucose and H₂SO₄ was heated at 180-220° C. for 3 h and then naturally cooled to room temperature. Next, the pH of the mixed solution was adjusted to 7 with Na₂CO₃. The mixed solution was centrifuged for 15 min at 12000 r/min and the resultant supernatant was extracted with a solid phase extraction column (Oasis HLB, 3 cc/60 mg, Waters). The extraction step comprises four steps: an activation step, an enrichment step, a separation step and an elution step. Specifically, in the activation step, the solid phase extraction column was rinsed with 20 mL methanol, and the residual methanol in the solid phase extraction column was then washed away with 40 mL ultrapure water. In the enrichment step, 20 mL CDs solution was extracted with a solid phase extraction column. In the separation step, the solid phase extraction column was rinsed with 40 mL ultrapure water to dissolve impurities such as inorganic salts. In the elution step, the solid phase extraction column was rinsed with 20 mL methanol to desorb the CDs to obtain high-purity methanol solution of CDs as the extract. Finally, the extract was purged with nitrogen and freeze-dried for 48 h to obtain CDs solid particles.

TiO₂ nanotubes were prepared by anodization. The TiO₂ nanotubes were immersed in a mixed solution of 25% by volume mercaptopropionic acid (MPA) and 15 g/L CDs, and were taken out after immersion for 48 h to obtain TiO₂ nanotube-CDs electrode.

The TiO₂ nanotube-CDs-PANI photocatalytic electrode was prepared by in-situ electropolymerization. The TiO₂ nanotube-CDs electrode, a platinum sheet and Ag/AgCl were used as a working electrode, a counter electrode and a reference electrode, respectively. The electrolyte was an acetone solution comprising 0.2 M aniline and 0.05 M citric acid. The electrolyte was deoxygenated with nitrogen for 30 minutes before in-situ electropolymerization. In-situ electropolymerization of aniline was carried out using cyclic voltammetry (potential: 0-0.8 V; number of polymerization cycles: 20 cycles). The working electrode after polymerization was dried at 60° C. for 24 h to obtain a TiO₂ nanotube-CDs-PANI photocatalytic electrode.

TiO₂ nanotube-CDs-WO₃ photocatalytic electrode was prepared by electrodeposition method. The TiO₂ nanotube-CDs electrode, a platinum sheet and Ag/AgCl were used as a working electrode, a counter electrode and a reference electrode, respectively. The electrolyte was 25 mM Na₂WO₄ and 30 mM H₂O₂ in water, and the pH of the solution was adjusted to 1.4±0.1 with 0.01 M HNO₃. The deposition voltage was −0.437 V_{Ag/AgCl}, and the deposition time was 150 s. The resulting electrode was cured at 60° C. for 12 h to obtain the TiO₂ nanotube-CDs-WO₃ photocatalytic electrode.

An experiment of simultaneous organic matter degradation and heavy metal reduction was performed using the prepared photocatalytic electrode. The photocatalytic electrode was immersed in a solution containing a certain concentration of organic pollutants and heavy metals, and then the working surface of the photocatalytic electrode was exposed to simulated sunlight for organic pollutant degradation and heavy metal reduction. The specific conditions were as follows: light intensity: 100 mW·cm⁻², wavelength: more than 420 nm; the ratio of electrode working area to solution volume: 7.5 cm²·L⁻¹; organic pollutant (carbamazepine) concentration: 10 μM; heavy metal (hexavalent chromium) concentration: 0.68 mM; reaction time: 60 min; no requirement of adjusting the pH value of the reaction system; and no requirement of aerating the reaction system.

As shown in FIG. 9, after loading of CDs and PANI, or CDs and WO₃, the degradation efficiency of the photocatalytic electrode on organic matter was increased from 21% (TiO₂ nanotubes) to 100% (TiO₂ nanotubes-CDs-PANI) and 85% (TiO₂ nanotubes-CDs-WO₃), showing an excellent degradation efficiency of organic matter.

As shown in FIG. 10, after loading of CDs and PANI, or CDs and WO₃, the reduction efficiency of the photocatalytic electrode on heavy metals was increased from 10% (TiO₂ nanotubes) to 76% (TiO₂ nanotubes-CDs-PANI) and 56% (TiO₂ nanotube-CDs-WO₃), showing an excellent reduction efficiency of heavy metal.

### EXAMPLE 7

CDs were prepared by the following steps. 4 g glucose was dissolved in 180 mL 98 wt % concentrated H₂SO₄. After introduced into a reactor with an inner tank of polytetrafluoroethylene, the mixed solution of glucose and H₂SO₄ was heated at 180° C. for 3 h and then naturally cooled to room temperature. Next, the pH of the mixed solution was adjusted to 7 with Na₂CO₃. The mixed solution was centrifuged for 15 min at 12000 r/min and the resultant supernatant was extracted with a solid phase extraction column (Oasis HLB, 3 cc/60 mg, Waters). The extraction step comprises four steps: an activation step, an enrichment step, a separation step and an elution step. Specifically, in the activation step, the solid phase extraction column was rinsed with 20 mL methanol, and the residual methanol in the solid phase extraction column was then washed away with 40 mL ultrapure water. In the enrichment step, 20 mL CDs solution was extracted with a solid phase extraction column. In the separation step, the solid phase extraction column was rinsed with 40 mL ultrapure water to dissolve impurities such as inorganic salts. In the elution step, the solid phase extraction column was rinsed with 20 mL methanol to desorb the CDs to obtain high-purity methanol solution of CDs as the extract. Finally, the extract was purged with nitrogen and freeze-dried for 48 h to obtain CDs solid particles.

Fe₂O₃ nanotubes were prepared by anodization. The Fe₂O₃ nanotubes were immersed in a mixed solution of 25% by volume mercaptopropionic acid (MPA) and 15 g/L CDs, and were taken out after immersion for 48 h to obtain Fe₂O₃ nanotube-CDs electrode.

Carbon nitride was formed on the CDs electron transport layer by a hydrothermal method. The prepared Fe₂O₃ nanotube-CDs electrode was immersed in an aqueous solution containing melamine 10 wt % and incubated at 80° C. for 24 h to obtain the Fe₂O₃ nanotube-CDs-carbon nitride photocatalytic electrode.

An experiment of simultaneous organic matter degradation and heavy metal reduction was performed using the prepared photocatalytic electrode. The photocatalytic electrode was immersed in a solution containing a certain concentration of organic pollutants and heavy metals, and then the working surface of the photocatalytic electrode was exposed to simulated sunlight for organic pollutant degradation and heavy metal reduction. The specific conditions were as follows: light intensity: 100 mW·cm⁻², wavelength: more than 420 nm; the ratio of electrode working area to solution volume: 7.5 cm²·L⁻¹; organic pollutant (carbamazepine) concentration: 10 μM; heavy metal (hexavalent chromium) concentration: 0.68 mM; reaction time: 60 min; no requirement of adjusting the pH value of the reaction system; and no requirement of aerating the reaction system.

As shown in FIG. 9, after loading of CDs and carbon nitride, the degradation efficiency of the photocatalytic electrode on organic matter was increased from 6% (Fe₂O₃ nanotubes) to 70% (Fe₂O₃ nanotubes-CDs-carbon nitride), showing an excellent degradation efficiency of organic matter.

As shown in FIG. 10, after loading of CDs and carbon nitride, the reduction efficiency of the photocatalytic electrode on heavy metals was increased from 4% (Fe₂O₃ nanotubes) to 79% (Fe₂O₃ nanotubes-CDs-carbon nitride), showing an excellent reduction efficiency of heavy metal.

### EXAMPLE 8

CDs were prepared by the following steps. 4 g glucose was dissolved in 180 mL 98 wt % concentrated H₂SO₄. After introduced into a reactor with an inner tank of polytetrafluoroethylene, the mixed solution of glucose and H₂SO₄ was heated at 220° C. for 3 h and then naturally cooled to room temperature. Next, the pH of the mixed solution was adjusted to 7 with Na₂CO₃. The mixed solution was centrifuged for 15 min at 12000 r/min and the resultant supernatant was extracted with a solid phase extraction column (Oasis HLB, 3 cc/60 mg, Waters). The extraction step comprises four steps: an activation step, an enrichment step, a separation step and an elution step. Specifically, in the activation step, the solid phase extraction column was rinsed with 20 mL methanol, and the residual methanol in the solid phase extraction column was then washed away with 40 mL ultrapure water. In the enrichment step, 20 mL CDs solution was extracted with a solid phase extraction column. In the separation step, the solid phase extraction column was rinsed with 40 mL ultrapure water to dissolve impurities such as inorganic salts. In the elution step, the solid phase extraction column was rinsed with 20 mL methanol to desorb the CDs to obtain high-purity methanol solution of CDs as the extract. Finally, the extract was purged with nitrogen and freeze-dried for 48 h to obtain CDs solid particles.

Fe₂O₃ nanotubes were prepared by anodization. The Fe₂O₃ nanotubes were immersed in a mixed solution of 25% by volume mercaptopropionic acid (MPA) and 15 g/L CDs, and were taken out after immersion for 48 h to obtain Fe₂O₃ nanotube-CDs electrode.

Carbon nitride was formed on the CDs electron transport layer by a hydrothermal method. The prepared Fe₂O₃ nanotube-CDs electrode was immersed in an aqueous solution containing melamine 30 wt % and incubated at 80° C. for 72 h to obtain the Fe₂O₃ nanotube-CDs-carbon nitride photocatalytic electrode.

An experiment of simultaneous organic matter degradation and heavy metal reduction was performed using the prepared photocatalytic electrode. The photocatalytic electrode was immersed in a solution containing a certain concentration of organic pollutants and heavy metals, and then the working surface of the photocatalytic electrode was exposed to simulated sunlight for organic pollutant degradation and heavy metal reduction. The specific conditions were as follows: light intensity: 100 mW·cm⁻², wavelength: more than 420 nm; the ratio of electrode working area to solution volume: 7.5 cm²·L⁻¹; organic pollutant (carbamazepine) concentration: 10 μM; heavy metal (hexavalent chromium) concentration: 0.68 mM; reaction time: 60 min; no requirement of adjusting the pH value of the reaction system; and no requirement of aerating the reaction system.

As shown in FIG. 9, after loading of CDs and carbon nitride, the degradation efficiency of the photocatalytic electrode on organic matter was increased from 6% (Fe₂O₃ nanotubes) to 65% (Fe₂O₃ nanotubes-CDs-carbon nitride), showing an excellent degradation efficiency of organic matter.

As shown in FIG. 10, after loading of CDs and carbon nitride, the reduction efficiency of the photocatalytic electrode on heavy metals was increased from 4% (Fe₂O₃ nanotubes) to 66% (Fe₂O₃ nanotubes-CDs-carbon nitride), showing an excellent reduction efficiency of heavy metal.

### COMPARATIVE EXAMPLE 1

TiO₂ nanotubes were prepared by anodization. The TiO₂ nanotube-PANI photocatalytic electrode was prepared by in-situ electropolymerization. The TiO₂ nanotube electrode, a platinum sheet and Ag/AgCl were used as a working electrode, a counter electrode and a reference electrode, respectively. The electrolyte was an acetone solution comprising 0.2 M aniline and 0.05 M citric acid. The electrolyte was deoxygenated with nitrogen for 30 minutes before in-situ electropolymerization. In-situ electropolymerization of aniline was carried out using cyclic voltammetry (potential: 0-0.8 V; number of polymerization cycles: 15 cycles). The working electrode after polymerization was dried at 60° C. for 24 h to obtain a TiO₂ nanotube- PANI photocatalytic electrode.

TiO₂ nanotube-WO₃ photocatalytic electrode was prepared by electrodeposition method. The TiO₂ nanotube electrode, a platinum sheet and Ag/AgCl were used as a working electrode, a counter electrode and a reference electrode, respectively. The electrolyte was 25 mM Na₂WO₄ and 30 mM H₂O₂ in water, and the pH of the solution was adjusted to 1.4±0.1 with 0.01 M HNO₃. The deposition voltage was −0.437 V_{Ag/AgCl}, and the deposition time was 150 s. The resulting electrode was cured at 60° C. for 18 h to obtain the TiO₂ nanotube-WO₃ photocatalytic electrode.

An experiment of simultaneous organic matter degradation and heavy metal reduction was performed using the prepared photocatalytic electrode. The photocatalytic electrode was immersed in a solution containing a certain concentration of organic pollutants and heavy metals, and then the working surface of the photocatalytic electrode was exposed to simulated sunlight for organic pollutant degradation and heavy metal reduction. The specific conditions were as follows: light intensity: 100 mW·cm⁻², wavelength: more than 420 nm; the ratio of electrode working area to solution volume: 7.5 cm²·L⁻¹; organic pollutant (carbamazepine) concentration: 1 M; heavy metal (hexavalent chromium) concentration: 6.8 M; reaction time: 60 min; no requirement of adjusting the pH value of the reaction system; and no requirement of aerating the reaction system.

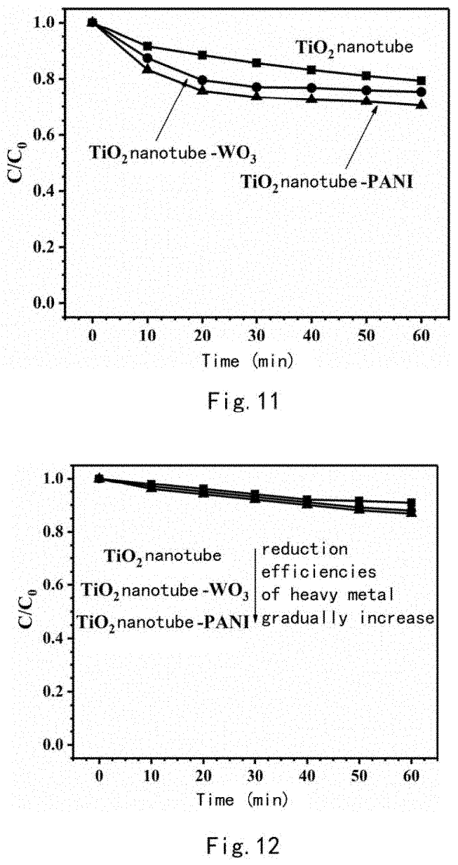

As shown in FIG. 11, after loading of PANI and WO₃, respectively, the degradation efficiency of the photocatalytic electrode on organic matter was increased from 21% (TiO₂ nanotubes) to 29% (TiO₂ nanotubes-CDs-PANI) and 23% (TiO₂ nanotubes-CDs-WO₃), showing a slight increase in degradation efficiency of organic matter.

As shown in FIG. 12, after loading of PANI and WO₃, respectively, the reduction efficiency of the photocatalytic electrode on heavy metals was increased from 10% (TiO₂ nanotubes) to 12% (TiO₂ nanotubes-PANI) and 11% (TiO₂ Nanotube-WO₃), showing a slight increase in reduction efficiency of heavy metal.

It was found that the efficiency of simultaneous organic matter degradation and heavy metal reduction could be significantly increased by introducing CDs as an electronic assistant into the photocatalytic electrode.

### COMPARATIVE EXAMPLE 2

CDs were prepared by the following steps. 4 g glucose was dissolved in 180 mL 98 wt % concentrated H₂SO₄. After introduced into a reactor with an inner tank of polytetrafluoroethylene, the mixed solution of glucose and H₂SO₄ was heated at 220° C. for 3 h and then naturally cooled to room temperature. Next, the pH of the mixed solution was adjusted to 7 with Na₂CO₃. The mixed solution was centrifuged for 15 min at 12000 r/min and the resultant supernatant was extracted with a solid phase extraction column (Oasis HLB, 3 cc/60 mg, Waters). The extraction step comprises four steps: an activation step, an enrichment step, a separation step and an elution step. Specifically, in the activation step, the solid phase extraction column was rinsed with 20 mL methanol, and the residual methanol in the solid phase extraction column was then washed away with 40 mL ultrapure water. In the enrichment step, 20 mL CDs solution was extracted with a solid phase extraction column. In the separation step, the solid phase extraction column was rinsed with 40 mL ultrapure water to dissolve impurities such as inorganic salts. In the elution step, the solid phase extraction column was rinsed with 20 mL methanol to desorb the CDs to obtain high-purity methanol solution of CDs as the extract. Finally, the extract was purged with nitrogen and freeze-dried for 48 h to obtain CDs solid particles.

Fe₂O₃ nanotubes were prepared by anodization. Two Fe₂O₃ nanotubes were immersed in a mixed solution of 25% by volume mercaptopropionic acid (MPA) and 15 g/L CDs and a solution of 15 g/L CDs without mercaptopropionic acid, and were taken out after immersion for 48 h to obtain TiO₂ nanotube-CDs electrode.

Carbon nitride was formed on the CDs electron transport layer by a hydrothermal method. The prepared Fe₂O₃ nanotube-CDs electrode was immersed in an aqueous solution containing melamine 30 wt % and incubated at 80° C. for 72 h to obtain the Fe₂O₃ nanotube-CDs-carbon nitride photocatalytic electrode.

An experiment of simultaneous organic matter degradation and heavy metal reduction was performed using the prepared photocatalytic electrode. The photocatalytic electrode was immersed in a solution containing a certain concentration of organic pollutants and heavy metals, and then the working surface of the photocatalytic electrode was exposed to simulated sunlight for organic pollutant degradation and heavy metal reduction. The specific conditions were as follows: light intensity: 100 mW·cm⁻², wavelength: more than 420 nm; the ratio of electrode working area to solution volume: 7.5 cm²·L⁻¹; organic pollutant (carbamazepine) concentration: 10 μM; heavy metal (hexavalent chromium) concentration: 0.68 mM; reaction time: 60 min; no requirement of adjusting the pH value of the reaction system; and no requirement of aerating the reaction system.

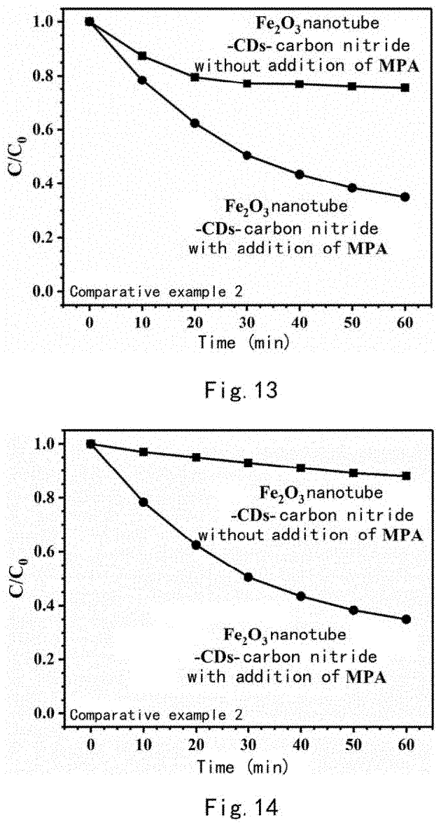

As shown in FIG. 13, in the case of no addition of MPA, the degradation efficiency of the Fe₂O₃ nanotube-CDs-carbon nitride photocatalytic electrode on organic matter was increased from 6% (Fe₂O₃ nanotubes) to 25%, and further increased to 65% after addition of MPA. It was confirmed that the addition of MPA facilitated immobilization of CDs and could further increase the degradation efficiency of organic matter.

As shown in FIG. 14, in the case of no addition of MPA, the reduction efficiency of the Fe₂O₃ nanotube-CDs-carbon nitride photocatalytic electrode on heavy metals was increased from 4% (Fe₂O₃ nanotubes) to 12%, and further increased to 66% after addition of MPA. It was confirmed that the addition of MPA facilitated immobilization of CDs and could further increase the reduction efficiency of heavy metals.

The specific embodiments further describe the purpose, technical solutions and beneficial effects of the present invention in detail. It should be understood that these are only specific embodiments of the present invention and are not intended to limit the present invention. Within the spirit and principle of the present invention, any modifications, equivalent replacements, modifications, etc., shall be included in the scope of the present invention.

1. A method for preparing a carbon dots (CDs)-based photocatalytic electrode for simultaneous organic matter degradation and heavy metal reduction, comprising:
forming a carbon dots electron transport layer on a semiconductor I;
forming a semiconductor II on the carbon dots electron transport layer.

2. The method according to claim 1, wherein the step of forming a carbon dots electron transport layer on the semiconductor I comprises:
immersing the semiconductor I in a mixed solution comprising 10 vol %-30 vol% (e.g., 15 vol %, 20 vol % or 25 vol %) mercaptopropionic acid (MPA) and 1-10 g/L (e.g., 2 g/L, 5 g/L or 8 g/L) CDs (preferably, the immersion time is 24-48 h), and then taking out the semiconductor I-CDs electrode.

3. The method according to claim 1, wherein the semiconductor I is a TiO₂ nanotube or a Fe₂O₃ nanotube.

4. The method according to claim 3, wherein the TiO₂ nanotube is a TiO₂ nanotube prepared by anodization, and the Fe₂O₃ nanotube is a Fe₂O₃ nanotube prepared by anodization.

5. The method according to claim 1, wherein the semiconductor II is an organic semiconductor or an inorganic semiconductor, wherein the organic semiconductor is polyaniline, reduced graphene oxide or carbon nitride; and the inorganic semiconductor is WO₃ or MoS₂.

6. The method according to claim 1, wherein the method of preparing carbon dots comprises: dissolving glucose in concentrated H₂SO₄, heating at 180-220° C. (e.g., 190° C., 200° C. or 210° C.) for 3-5 h (e.g., 3.5 h, 4 h or 4.5 h), cooling to room temperature, adjusting the pH of the mixed solution to 6.9-7.1, extracting the supernatant after centrifugation of the mixed solution by a solid phase extraction column, purging the extract with nitrogen and freeze-drying it (for example, freeze-drying time is 24-48 h) to obtain solid particles of carbon dots.

7. The method according to claim 6, wherein the solid phase extraction column is an HLB solid phase extraction column; preferably, the extraction step comprises rinsing the solid phase extraction column with methanol and then removing the residual methanol in the solid phase extraction column by ultrapure water; extracting the CDs solution by the solid phase extraction column; washing the solid phase extraction column by ultrapure water; and rinsing the solid phase extraction column by methanol to desorb the CDs to obtain a high-purity CDs-methanol solution.

8. A photocatalytic electrode prepared by the method of claim 1.

9. A method for simultaneously degrading organic matter and reducing heavy metals using the photocatalytic electrode according to claim 8, comprising:
immersing the photocatalytic electrode in a solution containing organic pollutants and heavy metals, and performing the degradation of organic pollutants and reduction of heavy metals under light exposure.

10. The method according to claim 9, wherein the reaction conditions are as follows: light intensity: more than 50 mW·cm⁻²; wavelength: more than 200 nm; the ratio of electrode working area to solution volume: 1-10 cm²·L⁻¹; concentration of the organic pollutant(s): less than 1 M; concentration of the heavy metal(s): less than 10 M; and reaction time: 30-120 min (such as 60 min or 90 min).
